(19) United States
(12) Patent Application Publication
(10) Pub. No.: US 2008/0090453 A1
(43) Pub. Date: Apr. 17, 2008

(54) Electric plate structure of socket

(76) Inventor: Jung-Hui Hsu, Chung Ho City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/653,213

(22) Filed: Jan. 16, 2007

(30) Foreign Application Priority Data
Oct. 17, 2006 (TW) 95218322

(51) Int. Cl. H01R 13/60

(52) U.S. Cl. 439/535

(57) ABSTRACT

An electric plate structure for a socket includes a baseplate and at least one contact piece. The contact piece defines a body portion and a protruding portion thereof, the body portion is connected with the baseplate, two sides of the body portion are bent inwards to form a clipping portion, the clipping portion extends towards one side to form a guide point, and the protruding portion is set on a surface of the body portion and the baseplate. Thereby, the electric plate structure of the socket is formed. The clipping portion is connected electronically with the pin of the plug, and the clipping portion is punched by a single baseplate. As such, it is unnecessary to set two baseplates to form the clipping portion. The quantity of copper can thereby be reduced, enhancing the profitability of products and their market competitiveness.

### BACKGROUND OF THE INVENTION

1. Field of the Invention

The present invention relates to an electric plate structure for a socket, and more specifically to an electric plate structure set in a socket for pins on a plug inserted therein.

2. Description of the Prior Art

A current socket is disclosed in TW patent 03602 (published on Mar. 1, 1981), entitled clip style socket (first prior art). The socket includes a socket shell, four clip plates, two electric connecting plates, an insulating motherboard, and a screw. The shapes of the four clip plates are the same, and the shapes of the two electric connecting plates are also the same.

However, because the cost of raw materials has risen sharply since the release of the aforementioned first prior art (specifically copper from which the clip plate is made), the price of the socket has risen several times over and continues to rise. For the socket, two clip plates are combined and connected to clip the pin of the plug, requiring even more copper and leading to somewhat higher production costs. Obviously these increasing costs adversely affect profits and market competitiveness.

Hence, the inventors of the present invention believe that the shortcomings described above are able to be improved upon and suggest the present invention which is of a reasonable design and is an effective improvement based on deep research and thought.

### SUMMARY OF THE INVENTION

An object of the present invention is to provide an electric plate structure for a socket, in which the quantity of copper is reduced, thereby allowing the profitability of products to be enhanced market competitiveness improved.

To achieve the above-mentioned object, an electric plate structure for a socket is disclosed. The electric plate structure includes a base plate and at least one contact piece, the contact piece defines a body portion and a protruding portion thereof, the body portion is connected with the baseplate, two sides of the body portion are bent inwards to form a clipping portion, the clipping portion extends towards one side to form a guide point, and the protruding portion is protruded out of the body portion and set on the baseplate.

The second electric plate structure for a socket includes a baseplate, which defines at least one hole thereon, and at least one contact piece, which defines a body portion and a protruding portion thereof. The body portion is connected with the baseplate, two sides of the body portion are bent inwards to form a clipping portion, the clipping portion extends towards one side to form a guide point, and the protruding portion is protruded out of the body portion and set on the baseplate.

The third electric plate structure of the socket includes a baseplate, which defines at least one protruding block thereon, and at least one contact piece, which defines a body portion and a protruding portion thereof. The body portion is connected with the baseplate, two sides of the body portion are bent inwards to form a clipping portion, the clipping portion extends towards one side to form a guide point, and the protruding portion is protruded out of the body portion and set on the baseplate.

The fourth electric plate structure of the socket includes a baseplate, which defines at least one protruding block and at least one hole thereon, and at least one contact piece, which defines a body portion and a protruding portion thereof. The body portion is connected with the baseplate, two sides of the body portion are bent inwards to form a clipping portion, the clipping portion extends towards one side to form a guide point, and the protruding portion is protruded out of the body portion and set on the baseplate.

The advantages of the present invention are that the two sides of the body portion are bent inwards to form the clipping portion, and the pin of the plug can be inserted into the clipping portion, so it is unnecessary to combine two baseplates to form the clipping portion. The quantity of copper is thereby reduced, and profitability and market competitiveness are increased.

To further understand the features and technical contents of the present invention, please refer to the following detailed description and drawings related to the present invention. However, the drawings are only to be used as references and explanations, and not to limit the present invention.

### BRIEF DESCRIPTION OF THE DRAWINGS

FIG. 1 is an isometric view of a first embodiment of an electric plate structure for a socket of the present invention;

FIG. 2 is an isometric view of a second embodiment of an electric plate structure for a socket of the present invention;

FIG. 3 is an isometric view of a third embodiment of an electric plate structure for a socket of the present invention;

FIG. 4 is an isometric view of a fourth embodiment of an electric plate structure for a socket of the present invention.

### DETAILED DESCRIPTION OF THE INVENTION

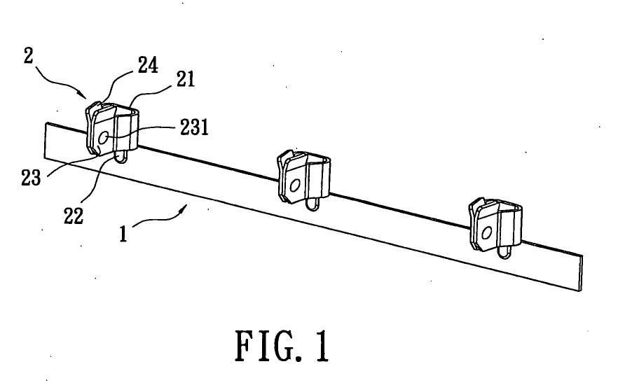

Referring to FIG. 1, an electric plate structure for a socket of the present invention is shown. The electric plate structure is fixed onto a socket for pins on a plug inserted therein (not shown). The electric plate includes a baseplate 1 and a plurality of contact pieces 2. The baseplate 1 and the contact pieces 2 are made of a metal material with good conductivity. The baseplate 1 is a strip-shaped plate and the contact pieces 2 are set on the baseplate 1 at intervals.

The contact pieces 2 are molded into the baseplate 1 by punching the contact pieces 2 on the baseplate 1. The contact pieces 2 are triangular and define a body portion 21 and a protruding portion 22 thereof. A bottom of the body portion 21 is connected with a top of the baseplate 1. Two sides of the body portion 21 are bent inwards to form a clipping portion 23. The pin of the plug can be inserted into the clipping portion 23 to connect electronically with the contact pieces 2. The clipping portion 23 extends upwards to form a guide point 24, which extends aslant towards two sides thereof to lead the pins in to the clipping portion 23. In addition, protruding points 231 are defined on two inside walls of the clipping portion 23 respectively to fix the pin inside the clipping portion 23.

The protruding portion 22 is set on a surface of the body portion 21 and the baseplate 1 to enhance the connection of the contact pieces 2 and the baseplate 1. This structure ensures that the contact pieces 2 do not bend due to the somewhat large force caused by inserting the pins. The electric plate structure for the socket of the present invention is thus formed.

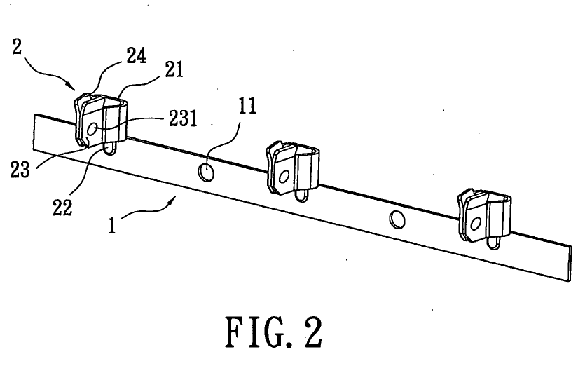

Referring to FIG. 2, a difference between the second embodiment and the first embodiment is that a plurality of holes 11 are defined on the baseplate 1 at intervals, the holes 11 are used as puller holes in the manufacturing process and for connecting to the power wire.

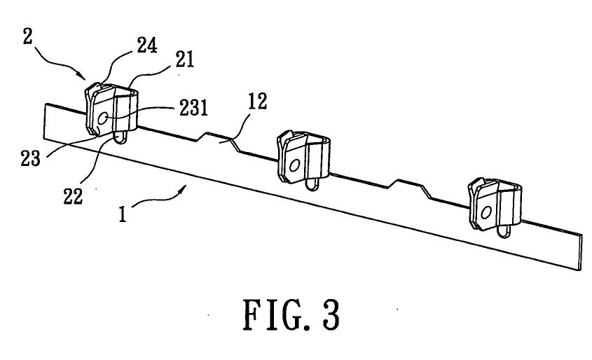

Referring to FIG. 3, a difference between the third embodiment and the first embodiment is that a plurality of protruding blocks 12 are defined on the baseplate 1 at intervals. The protruding blocks 12 extend upwards from the baseplate 1. In a following process, a jointing area of the baseplate 1 and a power wire can be increased due to the protruding blocks 12.

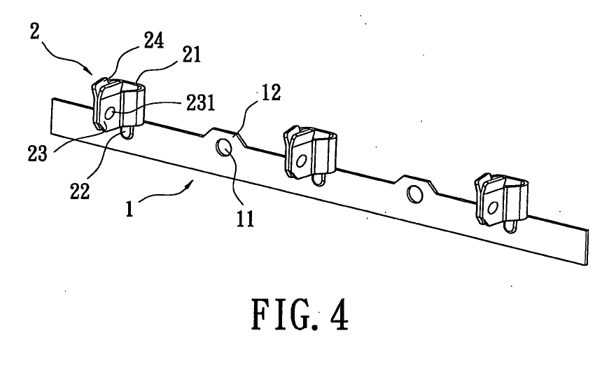

Referring to FIG. 4, a difference between the forth embodiment and the above-mentioned embodiment is that a plurality of holes 11 and a plurality of protruding blocks 12 are defined on the baseplate 1 with spaces between. The protruding blocks 12 extends upwards from the baseplate 1, the holes 11 are set on a surface of the protruding blocks 12 and the baseplate 1 at intervals. The holes 11 are used as puller holes in the manufacturing process and for connecting to a power wire. In the following process, a jointing area of the baseplate 1 and a power wire can be increased due to the protruding blocks 12.

For the electric plate structure for the socket of the present invention, the pin of the plug can be inserted into the clipping portion 23 to connect electronically with the contact pieces 2. The clipping portion 23 is punched on the baseplate 1, so it is unnecessary to combine two baseplates to form the clipping portion 23. The quantity of copper is thereby reduced, enhancing the profitability of products and their market competitiveness.

What is disclosed above are only the preferred embodiments of the present invention, and therefore it is intended that the present invention not be limited to the particular embodiment disclosed. It should be understood by those skilled in the art that various equivalent changes may be made depending on the specification and the drawings of present invention without departing from the scope of the present invention.

1. An electric plate structure fixed onto a socket for inserting the pins of a plug therein, comprising:
a baseplate, and
at least one contact piece defining a body portion connected with the baseplate a protruding portion protruding between the body portion and the baseplate, the body portion having two sides bent inwards and abutting each other to form a pair of clipping portions, each clipping portion being extended toward one side to form a guide point for guiding the plug pins into the clipping portions, each clipping portion having a protruding point on the inside wall thereof, for respectively fixing a plug pin inside the clipping portions.

2. (canceled)

3. The electric plate structure as claimed in claim 1, wherein the guide point extends aslant outwards to two sides.

4. The electric plate structure as claimed in claim 1, wherein the baseplate and the contact piece are made of a metal material with good conductivity.

5. An electric plate structure fixed onto a socket for inserting the pins of a plug therein, comprising:
a baseplate, having at least one hole displaced thereon, and
at least one contact piece defining a body portion connected with the baseplate, a protruding portion protruding between the body portion and the baseplate, the body portion having two sides inwards and abutting each other to form a pair of clipping portions each clipping portion being extended toward one side to form a guide point for guiding the plug pins into the clipping portions, each clipping portion having a protruding point on the inside wall thereof, for respectively fixing a plug pin inside the clipping portions.

6. (canceled)

7. The electric plate structure as claimed in claim 5, wherein the guide point extends aslant outwards to two sides.

8. The electric plate structure of the socket as claimed in claim 5, wherein the baseplate and the contact piece are made of a metal material with good conductivity.

9. The electric plate structure as claimed in claim 5, wherein a protruding block is set on the baseplate.

10. An electric plate structure fixed onto a socket for inserting the pins of a plug therein, comprising:
a baseplate, having at least one protruding block defined thereon, and
at least one contact piece defining a body portion connected with the baseplate, a protruding portion protruding between the body portion and the baseplate, the body portion having two sides bent inwards and abutting each other to form a pair of clipping portions, each clipping portion being extended toward one side to form a guide point for guiding the plug pins into the clipping portions, each clipping portion having a protruding point on the inside wall thereof, for respectively fixing a plug pin inside the clipping portions.

11. (canceled)

12. The electric plate structure as claimed in claim 10, wherein the guide point extends aslant outwards to two sides.

13. The electric plate structure of the socket as claimed in claim 10, wherein the baseplate and the contact piece are made of a metal material with good conductivity.

14. The electric plate structure of the socket as claimed in claim 10, wherein at least one hole is set on the baseplate.
